(19) United States
(12) Patent Application Publication
(10) Pub. No.: US 2024/0343941 A1
(43) Pub. Date: Oct. 17, 2024

(54) DUAL-CURE RESIN COMPOSITION COMPRISING URETDIONE-CONTAINING COMPOUND AND ITS USE IN 3D PRINTING

(71) Applicant: BASF SE, Ludwigshafen am Rhein (DE)

(72) Inventors: Rui DING, Shanghai (CN); Zhi Zhong CAI, Shanghai (CN); Yue WANG, Shanghai (CN)

(21) Appl. No.: 18/294,185

(22) PCT Filed: Jul. 27, 2022
(86) PCT No.: PCT/EP2022/071024

§ 371 Date: Feb. 1, 2024

(30) Foreign Application Priority Data
Aug. 2, 2021 (WO) PCT/CN2021/110084

(51) Int. Cl. C09D 175/14; B29C 64/124; B29C 71/02; B29C 71/04; B29K 105/00; B33Y 10/00; B33Y 40/20; B33Y 70/00; C08G 18/04; C08G 18/32; C08G 18/50; C08G 18/67; C08G 18/79

(52) U.S. Cl. CPC C09D 175/14; B33Y 70/00; C08G 18/04; C08G 18/3206; C08G 18/324; C08G 18/3243; C08G 18/325; C08G 18/5027; C08G 18/672; C08G 18/798; B29C 64/124; B29C 71/02; B29C 71/04; B29K 2105/0002; B29K 2105/0094; B29K 2995/0077; B29K 2995/0089; B33Y 10/00; B33Y 40/20

(57) ABSTRACT

This disclosure relates to a dual-cure resin composition comprising (a) at least one photo-polymerizable compound; (b) at least one uretdione-containing compound having an average uretdione ring functionality of greater than 1; (c) at least one compound containing at least one isocyanate-reactive group; and (d) at least one photoinitiator; to a process of forming 3D objects by using the composition, to use of the composition for forming 3D objects and to 3D objects formed by using the composition.

### TECHNOLOGY FIELD

The present invention relates to the technical field of chemical materials for three-dimensional (hereinafter referred to as “3D”) printing, and in particular relates to one-component (1 K) dual-cure resin composition, i.e., a dual-cure resin composition comprising uretdione-containing compound, to a process of forming 3D objects by using the composition, to use of the composition for forming 3D objects and to 3D objects formed by using the composition.

### BACKGROUND

Additive manufacturing (3D printing) describes a layer by layer construction of three-dimensional objects and as opposed to subtractive manufacturing methods, like milling or cutting, it allows for the preparation of highly complex shapes with no waste from unused build material. 3D printing techniques like stereolithography (SLA) or digital light processing (DLP) make use of photo-curable polymer resins and a respective light source to selectively cure the resin in a layer by layer fashion.

Urethane (meth)acrylates are the main components in photo-curable resins for 3D printing techniques such as stereolithography (SLA) and digital light processing (DLP). They provide certain tunability for mechanical properties which range from flexible, tough to rigid due to the rational combination of diisocyanate and polyol from urethane chemistry. However, the property boundary of urethane (meth)acrylate is still limited because the repeating urethane unit in the oligomer chain rarely forms like conventional PU chain and cross-linking through multifunctional acrylates takes effect to trade off mechanical properties.

In order to improve the mechanical tunability and expand the property boundary of photo-curable resins, U.S. Pat. No. 9,453,142 discloses urethane (meth)acrylate compositions based on a dual-cure mechanism. The materials were designed for continuous liquid interface production, containing blocked or reactive blocked prepolymers or diisocyanates. The composition, however, needs to be used as two-component due to its insufficient storage stability within a printing mixture.

Currently, the photo-curable resins based on urethane (meth)acrylates as 1K system in general suffer from unsatisfied mechanical properties, which limit their applications in high-performance scenarios.

Therefore, there is a strong need to provide a dual-cure 1 K resin composition with good storage stability which enables easy to process with high flexibility, and meanwhile good printability and improved mechanical properties, especially improved impact strength to enable the development of 3D objects.

### SUMMARY OF THE INVENTION

It is an object of the invention to provide a dual-cure resin composition with good storage stability, and meanwhile good printability and improved mechanical properties, especially improved impact strength to enable the development of 3D objects, wherein the dual-cure resin composition comprises (a) at least one photo-polymerizable compound; (b) at least one uretdione-containing compound having an average uretdione ring functionality of greater than 1; (c) at least one compound containing at least one isocyanate-reactive groups; and (d) at least one photoinitiator.

Another object of the present invention is to provide a process of forming 3D objects by using the composition.

A further object of the present invention is to provide use of the composition for forming 3D objects.

A yet further object of the present invention is to provide 3D objects formed by using the composition.

It has been surprisingly found that the above objects can be achieved by following embodiments:

1. A dual-cure resin composition comprising
(a) at least one photo-polymerizable compound;
(b) at least one uretdione-containing compound having an average uretdione ring functionality of greater than 1;
(c) at least one compound containing at least one, preferably at least two isocyanate-reactive groups; and
(d) at least one photoinitiator.

2. The dual-cure resin composition according to embodiment 1, wherein component (a) comprises at least one monomer and/or oligomer containing one or more ethylenically unsaturated functional groups.

3. The dual-cure resin composition according to embodiment 1 or 2, wherein the amount of component (a) is in the range from 10 to 95 wt. %, preferably from 15 to 80 wt. %, more preferably from 20 to 70 wt. %, based on the total weight of the dual-cure resin composition.

4. The dual-cure resin composition according to embodiment 2 or 3, wherein the monomer includes (meth)acrylamides, (meth)acrylates, vinylamides, vinyl substituted heterocycles, di-substituted alkenes and mixtures thereof.

5. The dual-cure resin composition according to any of embodiments 2 to 4, wherein the oligomer containing one or more ethylenically unsaturated functional groups is selected from the following classes: urethane, polyether, polyester, polycarbonate, polyestercarbonate, epoxy, polybutadiene, silicone or any combination thereof; preferably, the oligomer containing one or more ethylenically unsaturated functional groups is selected from the following classes: a urethane-based oligomer, an epoxy-based oligomer, a polyester-based oligomer, a polyether-based oligomer, a urethane acrylate-based oligomer, a polyether urethane-based oligomer, a polyester urethane-based oligomer, a polybutadiene-based oligomer or a silicone-based oligomer, as well as any combination thereof.

6. The dual-cure resin composition according to any of embodiments 2 to 5, wherein component (a) comprises at least one monomer and oligomer containing one or more ethylenically unsaturated functional groups and the weight ratio of the monomer to the oligomer in component (a) is in the range from 10:90 to 90:10, preferably from 30:70 to 70:30, more preferably from 40:60 to 60:40.

7. The dual-cure resin composition according to any of embodiments 1 to 6, wherein the uretdione-containing compound has an average uretdione ring functionality of 1.2 to 10, preferably 2 to 8, more preferably 3 to 6.

8. The dual-cure resin composition according to any of embodiments 1 to 7, wherein the uretdione-containing compound is based on the (cyclo)aliphatic diisocyanates, preferably 1,2-ethylene diisocyanate; 1,4-tetramethylene diisocyanate; 1,6-hexamethylene diisocyanate; 2,2,4-trimethyl-1,6-hexamethylene diisocyanate; 2,4,4-trimethyl-1,6-hexamethylene diisocyanate; 1,9-diisocyanato-5-methylnonane; 1,8-diisocyanato-2,4-dimethyloctane; 1,12-dodecane diisocyanate; ω,ω′-diisocyanatodipropyl ether; cyclobutene 1,3-diisocyanate; cyclohexane 1,3-diisocyanate; cyclohexane 1,4-diisocyanate; or 3-isocyanatomethyl-3,5,5-trimethylcyclohexyl isocyanate (isophorone diisocyanate, IPDI), more preferably 3-isocyanatomethyl-3,5,5-trimethylcyclohexyl isocyanate.

9. The dual-cure resin composition according to any of embodiments 1 to 8, wherein the total amount of component (b) is in the range from 1 to 50 wt. %, preferably from 2 to 40 wt. %, more preferably from 5 to 30 wt. %, based on the total weight of the dual-cure resin composition.

10. The dual-cure resin composition according to any of embodiments 1 to 9, wherein component (c) comprises monoalcohols, diols and/or polyols, preferably monoalcohols or diols having 2 to 20 carbon atoms, or polyester polyols, polycarbonate polyols, polyether polyols, 1,2-, 1,3- or 1,4-butanediol, 1,6-hexanediol, polytetrahydrofuran (PolyTHF) having a number-average molecular weight of 250 to 5000 g/mol, or 500 to 2000 g/mol, polypropylene glycol (PPG) having a number-average molecular weight of 250 to 5000 g/mol, or 500 to 2000 g/mol or polyethylene glycol (PEG) having a number-average molecular weight of 250 to 5000 g/mol, or 500 to 2000 g/mol, more preferably 1,4-butanediol, polypropylene glycol 1000 (PPG1000) or polytetrahydrofuran 2000 (PolyTHF2000).

11. The dual-cure resin composition according to any of embodiments 1 to 9, wherein component (c) comprises aromatic monoamines, diamines and/or polyamines, preferably aniline, C₁-C₈-alkyl substituted aniline, di-C₁-C₈-alkyl substituted aniline, C₁-C₈-alkoxy substituted aniline and di-C₁-C₈-alkoxy substituted aniline, 1,4-diaminobenzene, 2,4- and/or 2,6-diaminotoluene, m-xylylenediamine, 2,4′- and/or 4,4′-diaminodiphenylmethane, 3,3′-dimethyl-4,4′-diaminodiphenylmethane, 3,3′-dichloro-4,4′-diaminodiphenylmethane, 3,5-dimethylthiotoluene-2,4- and/or-2,6-diamine, 1,3,5-triethyl-2,4-diaminobenzene, 1,3,5-triisopropyl-2,4-diaminobenzene, 1-methyl-3,5-diethyl-2,4- and/or-2,6-diaminobenzene, 4,6-dimethyl-2-ethyl-1,3-diaminobenzene, delayed action 4,4′-methylene dianiline, diethyltoluene diamine, N,N′-disec-butyl-4,4′-methylene dianiline, or polytetramethylene glycol bis(4-aminobenzoate) with a molecular weight of from 300 to 1000 g/mol, and mixtures thereof, preferably delayed action 4,4′-methylene dianiline, diethyltoluene diamine, N,N′-di-sec-butyl-4,4′-methylene dianiline, or polytetramethylene glycol bis(4-aminobenzoate) with a molecular weight of from 300 to 1000 g/mol, preferably 400 to 800 g/mol, more preferably 500 to 700 g/mol.

12. The dual-cure resin composition according to any of embodiments 1 to 11, wherein the total amount of component (c) is in the range from 1 to 50 wt. %, preferably from 2 to 40 wt. %, more preferably from 5 to 30 wt. %, based on the total weight of the dual-cure resin composition.

13. The dual-cure resin composition according to any of embodiments 1 to 12, wherein the dual-cure resin composition exhibits no more than 10% change in viscosity at 25° C. after storage for 1, 2, 3 or 4 weeks at room temperature, preferably no more than 9%, no more than 8%, no more than 7%, no more than 6%; more preferably no more than 5%, no more than 4%, no more than 3%, or no more than 2% change in viscosity at 25° C. after storage for 1, 2, 3 or 4 weeks at room temperature.

14. A process of forming 3D object, comprises the following steps:
(i) applying radiation to cure the dual-cure resin composition according to any of embodiments 1 to 13 layer by layer to form an intermediate 3D object;
(ii) removing the excessive liquid resin from the intermediate object obtained in step (i), optionally followed by radiation post-curing the intermediate 3D object obtained in step (i) as a whole; and
(iii) thermal treating the object obtained in step (ii) as a whole to form a final 3D object.

15. Use of the dual-cure resin composition according to any of embodiments 1 to 13 for forming 3D objects.

16. A 3D object formed from the dual-cure resin composition according to any of embodiments 1 to 13 or obtained by the process according to embodiment 14.

17. The 3D object according to embodiment 16, wherein the 3D object includes plumbing fixtures, household, toy, jig, mould and interior part and connector within a vehicle.

The dual-cure resin composition according to the present invention is a 1 K dual-cure resin composition comprising uretdione-containing compound, shows excellent storage stability and excellent printing accuracy, and meanwhile good printability and improved mechanical properties, especially improved impact strength to enable the development of 3D objects. Furthermore, the dual-cure resin composition according to the present invention may be essentially free of isocyanates. This can be advantageous because the composition containing isocyanates exhibit more sensitivity to water, so minimizing an isocyanate content in the composition may improve reliability during curing as well as simplify storage and handling of the composition.

### EMBODIMENT OF THE INVENTION

The undefined article “a”, “an”, “the” means one or more of the species designated by the term following said article.

In the context of the present disclosure, any specific values mentioned for a feature (comprising the specific values mentioned in a range as the end point) can be recombined to form a new range.

In the context of the present disclosure, 3D printing refers to a process of forming a 3D-printed object by using the composition.

### Dual-Cure Resin Composition

One aspect of the present invention is directed to a dual-cure resin composition comprising
(a) at least one photo-polymerizable compound;
(b) at least one uretdione-containing compound having an average uretdione ring functionality of greater than 1;
(c) at least one compound containing at least one isocyanate-reactive group; and
(d) at least one photoinitiator.

The dual-cure resin composition of the present invention is a 1K dual-cure resin composition. The dual-cure resin composition of the present invention shows excellent storage stability.

According to the present invention, the dual-cure resin composition exhibits no more than 10% change in viscosity at 25° C. after storage for 1, 2, 3 or 4 weeks at room temperature, preferably no more than 9%, no more than 8%, no more than 7%, no more than 6%; more preferably no more than 5%, no more than 4%, no more than 3%, or no more than 2% change in viscosity at 25° C. after storage for 1, 2, 3 or 4 weeks at room temperature.

Room temperature refers generally to a temperature of 25±2° C.

Viscosity (such as the viscosity of the dual-cure resin composition) can be measured by using a Brookfield AMETEK DV3T rheometer. For each test, approximately 0.65 ml of specimen was used, and a shear rate between 1 s⁻¹ and 30 s⁻¹ was selected according to the viscosity.

The viscosity of the dual-cure resin composition of the present invention depends on the specific printing process. Usually, the dual-cure resin composition of the present invention has a viscosity at 25° C. of no more than 8000 mPa·s, preferably no more than 6000 mPa·s, more preferably no more than 4000 mPa·s, in particular no more than 3000 mPa·s.

### Photo-Polymerizable Compound (a)

The dual-cure resin composition of the present invention comprises at least one photo-polymerizable compound as component (a).

According to a preferred embodiment of the invention, the functionality of the photo-polymerizable compound can be in the range from 1 to 30, for example 1.2, 1.5, 1.8, 2, 2.2. 2.5, 3, 3.5,4, 5, 6, 7, 8, 9, 10, 11, 12, 13, 14, 15, 16, 17, 18, 19, 20, 21, 22, 23, 24, 25, 26, 27, 28, 29, preferably 1 to 8, or 1.5 to 6, or 1.5 to 4.

According to the present invention, component (a) can comprise at least one monomer and/or oligomer containing one or more ethylenically unsaturated functional groups. A person skilled in the art could understand that the ethylenically unsaturated functional group in the context of the present disclosure is a radiation-curable group.

The amount of component (a) can be in the range from 10 to 95 wt. %, for example 15 wt. %, 20 wt. %, 25 wt. %, 30 wt. %, 35 wt. %, 40 wt. %, 45 wt. %, 50 wt. %, 55 wt. %, 60 wt. %, 65 wt. %, 70 wt. %, 75 wt. %, 80 wt. %, 85 wt. % or 90 wt. %, preferably from 15 to 80 wt. %, more preferably from 20 to 70 wt. %, based on the total weight of the dual-cure resin composition.

The monomer can include (meth)acrylamides, (meth)acrylates, vinylamides, vinyl substituted heterocycles, di-substituted alkenes and mixtures thereof.

Examples of suitable (meth)acrylamides can include acryloylmorpholine, methacryloylmorpholine, N-(hydroxymethyl) (meth)acrylamide, N-hydroxyethyl (meth)acrylamide, N-isopropyl (meth)acrylamide, N-tert-butyl (meth)acrylamide, N,N′-methylene bis(meth)acrylamide, N-(isobutoxymethyl) (meth)acrylamide, N-(butoxymethyl) (meth)acrylamide, N-[3-(dimethylamino)propyl] (meth)acrylamide, N,N-dimethyl (meth)acrylamide, N,N-diethyl (meth)acrylamide, N-hydroxymethyl (meth)acrylamide, N-hydroxyethyl (meth)acrylamide, N-isopropyl (meth)acrylamide and mixtures thereof.

Examples of suitable (meth)acrylates can include monofunctional (meth)acrylates, such as isobornyl (meth)acrylate, tetrahydrofurfuryl (meth)acrylate, ethoxylated phenyl (meth)acrylate, cyclohexyl(meth)acrylate, lauryl (meth)acrylate, stearyl (meth)acrylate, octyl (meth)acrylate, isodecyl (meth)acrylate, tridecyl (meth)acrylate, caprolactone (meth)acrylate, nonyl phenol (meth)acrylate, cyclic trimethylolpropane formal (meth)acrylate, methoxy polyethyleneglycol (meth)acrylates, methoxy polypropyleneglycol (meth)acrylates, hydroxyethyl (meth)acrylate, hydroxypropyl (meth)acrylate, glycidyl (meth)acrylate; bifunctional (meth)acrylates, such as 1,3-butylene glycol di(meth)acrylate, 1,4-butanediol di(meth)acrylate, diethylene glycol di(meth)acrylate, 1,6-hexanediol di(meth)acrylate, tetraethylene glycol di(meth)acrylate, triethylene glycol di(meth)acrylate, tripropylene glycol di(meth)acrylate, dipropylene glycol di(meth)acrylate, alkoxylated hexanediol di(meth)acrylate, tricyclodecane dimethanol di(meth)acrylate, 1,9-nonanediol di(meth)acrylate, 1,10-decanediol di(meth)acrylate, neopentyl glycol di(meth)acrylate, polytetramethylene glycol di(meth)acrylate, 3-methyl-1,5-pentanediol di(meth)acrylate, dimethylol-tricyclodecane di(meth)acrylate; trifunctional (meth)acrylates, such as trimethylolpropane tri(meth)acrylate; tetrafunctional (meth)acrylates, such as bistrimethylolpropane tetra(meth)acrylate, pentaerythritol tetra(meth)crylate, tetramethylolmethane tetra(meth)acrylate, ethoxylated pentaerythritol tetra(meth)acrylate, propoxylated pentaerythritol tetra(meth)acrylate, dipentaerythritol tetra(meth)acrylate, ethoxylated dipentaerythritol tetra(meth)acrylate, propoxylated dipentaerythritol tetra(meth)acrylate, aryl urethane tetra(meth)acrylates, aliphatic urethane tetra(meth)acrylates, melamine tetra(meth)acrylates and mixtures thereof.

Examples of suitable vinylamides can include N-(hydroxymethyl)vinylamide, N-hydroxyethyl vinylamide, N-isopropylvinylamide, N-isopropylmethvinylamide, N-tert-butylvinylamide, N,N′-methylenebisvinylamide, N-(isobutoxymethyl)vinylamide, N-(butoxymethyl)vinylamide, N-[3-(dimethylamino)propyl]methvinylamide, N,N-dimethylvinylamide, N,N-diethylvinylamide, Nmethyl-N-vinylacetamide and mixtures thereof.

Examples of suitable vinyl substituted heterocycles can include monovinyl substituteted heterocycles, wherein the heterocycle is a 5- to 8-membered ring containing 2 to 7 carbon atoms, and 1 to 4 (preferably 1 or 2) heteroatoms selected from N, O and S, such as vinylpyridines, N-vinylpyrrolidone, N-vinylmorpholin-2-one, N-vinyl caprolactam and 1-vinylimidazole, vinyl alkyl oxazolidinone such as vinyl methyl oxazolidinone. Particularly preferred are Nvinyloxazolidinone (VOX) and N-vinyl-5-methyl oxazolidinone (VMOX), most preferred is VMOX.

Di-substituted alkene refers to an alkene in which two of the substituents directly attached to the double-bonded carbon atoms are substituents that are other than hydrogen, preferably a hydrocarbyl group, more preferably straight or branched chain alkyl, straight or branched chain alkenyl, straight or branched chain alkynyl, cycloalkyl, alkyl substituted cycloalkyl, aryl, aralkyl, or alkaryl, wherein the hydrocarbyl groups may contain one or more heteroatoms in the backbone of the hydrocarbyl group. Both of the substituents can be attached to the same carbon of the carbon-carbon double bond. Alternatively, one substituent can be attached to each of the double-bonded carbons. Examples of suitable di-substituted alkenes can include 1,1-di-substituted alkenes, preferably α-methylstyrene, 2-methyl-1-butene, 2-methylhept-1-ene, and 1,2-disubstituted alkenes, preferably cyclohexene or 2-methylhept-2-ene.

In one embodiment of the invention, the oligomer contains a core structure linked to the ethylenically unsaturated functional group, optionally via a linking group. The linking group can be an ether, ester, amide, urethane, carbonate, or carbonate group. In some instances, the linking group is part of the ethylenically unsaturated functional group, for instance an acryloxy or acrylamido group. The core group can be an alkyl (straight and branched chain alkyl groups), aryl (e.g. phenyl), polyether, polyester, siloxane, urethane, or other core structures and oligomers thereof. Suitable ethylenically unsaturated functional group may comprise carbon-carbon double bond such as methacrylate, acrylate, vinyl ether, allyl ether, acrylamide, methacrylamide, or a combination thereof. In some embodiments, suitable oligomer comprise mono- and/or polyfunctional acrylate, such as mono (meth)acrylate, di(meth)acrylate, tri(meth)acrylate, or higher, or combination thereof. Optionally, the oligomer may include a siloxane backbone in order to further improve cure, flexibility and/or additional properties of the dual-cure resin composition for creation of objects with single or multiple layers.

In some embodiments, the oligomer can be selected from the following classes: urethane (i.e. a urethane-based oligomer containing ethylenically unsaturated functional group), polyether (i.e. an polyether-based oligomer containing ethylenically unsaturated functional group), polyester (i.e. an polyester-based oligomer containing ethylenically unsaturated functional group), polycarbonate (i.e. an polycarbonate-based oligomer containing ethylenically unsaturated functional group), polyestercarbonate (i.e. an polyestercarbonate-based oligomer containing ethylenically unsaturated functional group), epoxy (i.e. an epoxy-based oligomer containing ethylenically unsaturated functional group), silicone (i.e. a silicone-based oligomer containing ethylenically unsaturated functional group), polybutadiene (i.e. a polybutadiene-based oligomer containing ethylenically unsaturated functional group) or any combination thereof. Preferably, the reactive oligomer containing at least one ethylenically unsaturated functional group can be selected from the following classes: a urethane-based oligomer, an epoxy-based oligomer, a polyester-based oligomer, a polyether-based oligomer, a urethane acrylate-based oligomer, a polyether urethane-based oligomer, a polyester urethane-based oligomer, a silicone-based oligomer or a polybutadiene-based oligomer, as well as any combination thereof.

In one embodiment, the oligomer comprises a urethane-based oligomer comprising urethane repeating units and one or more ethylenically unsaturated functional groups, for example carbon-carbon unsaturated double bond such as (meth)acrylate, (meth)acrylamide, allyl and vinyl groups. Preferably, the oligomer contains at least one urethane linkage (for example, one or more urethane linkages) within the backbone of the oligomer molecule and at least one acrylate and/or methacrylate functional groups (for example, one or more acrylate and/or methacrylate functional groups) pendent to the oligomer molecule. In some embodiments, aliphatic, cycloaliphatic, or mixed aliphatic and cycloaliphatic urethane repeating units are suitable. Urethanes are typically prepared by the condensation of a diisocyanate with a diol. Aliphatic urethanes having at least two urethane moieties per repeating unit are useful. In addition, the diisocyanate and diol used to prepare the urethane comprise divalent aliphatic groups that may be the same or different.

In one embodiment, the oligomer comprises polyester urethane-based oligomer or polyether urethane-based oligomer containing at least one ethylenically unsaturated functional group. The ethylenically unsaturated functional group can be carbon-carbon unsaturated double bond, such as acrylate, methacrylate, vinyl, allyl, acrylamide, methacrylamide, etc., preferably acrylate and methacrylate. The functionality of these polyester or polyether urethane-based oligomer is 1 or greater, specifically about 2 ethylenically unsaturated functional groups per oligomer molecule.

Suitable urethane-based oligomers are known in the art and may be readily synthesized by a number of different procedures. For example, a polyfunctional alcohol may be reacted with a polyisocyanate (preferably, a stoichiometric excess of polyisocyanate) to form an NCO-terminated pre-oligomer, which is thereafter reacted with a hydroxy-functional ethylenically unsaturated monomer, such as hydroxy-functional (meth)acrylate. The polyfunctional alcohol may be any compound containing two or more OH groups per molecule and may be a monomeric polyol (e.g., a glycol), a polyester polyol, a polyether polyol or the like. The urethane-based oligomer in one embodiment of the invention is an aliphatic urethane-based oligomer containing (meth)acrylate functional group.

Suitable polyether or polyester urethane-based oligomers include the reaction product of an aliphatic or aromatic polyether or polyester polyol with an aliphatic or aromatic polyisocyanate that is functionalized with a monomer containing the ethylenically unsaturated functional group, such as (meth)acrylate group. In one embodiment, the polyether and polyester are aliphatic polyether and polyester, respectively. In one embodiment, the polyether and polyester urethane-based oligomers are aliphatic polyether and polyester urethane-based oligomers and comprise (meth)acrylate group.

Epoxy-based oligomer containing at least one ethylenically unsaturated functional group can be epoxy-based (meth)acrylate oligomer. The epoxy-based (meth)acrylate oligomer is obtainable by reacting epoxides with (meth)acrylic acid.

Examples of suitable epoxides include epoxidized olefins, epoxidized unsaturates, aromatic glycidyl ethers or aliphatic glycidyl ethers, especially those of aromatic or aliphatic glycidyl ethers.

Examples of possible epoxidized olefins include ethylene oxide, propylene oxide, isobutylene oxide, 1-butene oxide, 2-butene oxide, vinyloxirane, styrene oxide or epichlorohydrin, preference being given to ethylene oxide, propylene oxide, isobutylene oxide, vinyloxirane, styrene oxide or epichlorohydrin, particular preference to ethylene oxide, propylene oxide or epichlorohydrin, and very particular preference to ethylene oxide and epichlorohydrin.

Examples of epoxidized unsaturates include epoxidized soybean oil, epoxidized linseed oil, epoxidized castor oil, epoxidized palm oil, epoxidized vegetable oil or epoxidized sucrose soyate.

Aromatic glycidyl ethers are, for example, bisphenol A diglycidyl ether, bisphenol F diglycidyl ether, bisphenol B diglycidyl ether, bisphenol S diglycidyl ether, hydroquinone diglycidyl ether, alkylation products of phenol/dicyclopentadiene, e.g., 2,5-bis[(2,3-epoxypropoxy)phenyl]octahydro-4,7-methano-5H-indene (CAS No. [13446-85-0]), tris[4-(2,3-epoxypropoxy)phenyl]methane isomers (CAS No. [66072-39-7]), phenol-based novolac epoxy (CAS No. [9003-35-4]), and cresol-based novolac epoxy (CAS No. [37382-79-9]).

Examples of aliphatic glycidyl ethers include 1,4-butanediol diglycidyl ether, 1,6-hexanediol diglycidyl ether, trimethylolpropane triglycidyl ether, pentaerythritol tetraglycidyl ether, 1,1,2,2-tetrakis[4-(2,3-epoxypropoxy)phenyl]ethane (CAS No. [27043-37-4]), diglycidyl ether of polypropylene glycol (α,ω-bis(2,3-epoxypropoxy)poly(oxypropylene), CAS No. [16096-30-3]) and hydrogenated bisphenol A (2,2-bis[4-(2,3-epoxypropoxy)cyclohexyl]propane, CAS No. [13410-58-7]).

In one embodiment, the epoxy-based (meth)acrylate oligomer is an aromatic glycidyl (meth)acrylate.

Polycarbonate-based oligomer containing at least one ethylenically unsaturated functional group can comprise polycarbonate-based (meth)acrylates oligomer, which is obtainable in a simple manner by trans-esterifying carbonic esters with polyhydric, preferably dihydric, alcohols (diols, hexanediol for example) and subsequently esterifying the free OH groups with (meth)acrylic acid, or else by transesterification with (meth)acrylic esters, as described for example in EP-A 92 269. They are also obtainable by reacting phosgene, urea derivatives with polyhydric, e.g., dihydric, alcohols.

Also conceivable are (meth)acrylates of polycarbonate polyols, such as the reaction product of one of the aforementioned diols or polyols and a carbonic ester and also a hydroxyl-containing (meth)acrylate.

Examples of suitable carbonic esters include ethylene carbonate, 1,2- or 1,3-propylene carbonate, dimethyl carbonate, diethyl carbonate or dibutyl carbonate.

Examples of suitable hydroxyl-containing (meth)acrylates are 2-hydroxyethyl (meth)acrylate, 2- or 3-hydroxypropyl (meth)acrylate, 1,4-butanediol mono(meth)acrylate, neopentyl glycol mono(meth)acrylate, glyceryl mono- and di(meth)acrylate, trimethylolpropane mono- and di(meth)acrylate, and pentaerythritol mono-, di-, and tri(meth)acrylate.

Silicone-based oligomer containing at least one ethylenically unsaturated functional group can comprise silicone-based (meth)acrylates oligomer, which is obtainable by addition or condensation of functionalized (meth)acrylate monomers with silicone resin. Examples of the silicone-based (meth)acrylates oligomer include DMS-R18, DMS-R22, DMS-R31, RMS-033, RMS-044, RMS-083 (Gelest); CN990, CN9800 (Sartomer); Miramer SIU2400, Miramer SIP910 (Miwon). Polybutadiene-based oligomer containing at least one ethylenically unsaturated functional group can comprise polybutadiene-based (meth)acrylates oligomer, which is obtainable by addition of functionalized (meth)acrylate monomers with hydroxyl terminated polybutadiene. Examples of the polybutadiene-based (meth)acrylates oligomer include BR-640D, BR-641 D, BR-643 (Dymax); Hypro 2000X168LC VTB, Hypro 1300X33LC VTBNX, Hypro 1300X43LC VTBNX (CVC), CN301, CN303 (Sartomer), TEAI-1000, TE-2000 (NIPPON SODA CO). Polybutadiene can be hydrogenated, epoxidized, or copolymerized with acrylonitrile.

The oligomer preferably has a number-average molar weight Mn of 200 to 20 000, more preferably of 200 to 10 000 g/mol, and most preferably of 250 to 3000 g/mol.

In one embodiment, the oligomer has a glass transition temperature in the range from −130 to 350° C., for example −120° C., −110° C., −100° C., −90° C., −80° C., −70° C., −60° C., −50° C., −40° C., −30° C., −20° C., −10° C., 0° C., 5° C., 10° C., 20° C., 30° C., 40° C., 50° C., 80° C., 100° C., 120° C., 150° C., 180° C., 190° C., 200° C., 220° C., 230° C., 250° C., 280° C., 300° C., 310° C., 320° C., 330° C., or 340° C., preferably from −70 to 300° C., more preferably from 0 to 280° C.

In another embodiment, the viscosity of the oligomer at 60° C. can be in the range from 10 to 100000 mPa·s, for example 20 mPa·s, 50 mPa·s, 100 mPa·s, 200 mPa·s, 500 mPa·s, 800 mPa·s, 1000 mPa·s, 2000 mPa·s, 3000 mPa·s, 4000 mPa·s, 5000 mPa·s, 6000 mPa·s, 7000 mPa·s, 8000 mPa·s, 10000 mPa·s, 20000 mPa·s, 30000 mPa·s, 40000 mPa·s, 50000 mPa·s, 60000 mPa·s, 70000 mPa·s, 80000 mPa·s, 90000 mPa·s, 95000 mPa·s, preferably from 20 to 80000 mPa·s, for example from 100 to 15000 mPa·s, or from 1000 to 80000 mPa·s.

In a further embodiment, component (a) comprises at least one monomer and oligomer containing one or more ethylenically unsaturated functional groups and the weight ratio of the monomer to the oligomer in component (a) can be in the range from 10:90 to 90:10, for example 15:85, 20:80, 25:75, 30:70, 35:65, 40:60, 45:55, 50:50, 55:45, 60:40, 65:35, 70:30, 75:25, 80:20, 85:15, preferably from 30:70 to 70:30, more preferably from 40:60 to 60:40.

### Uretdione-Containing Compound (b)

The dual-cure resin composition of the present invention comprises at least one uretdione-containing compound as component (b). According to the present invention, said uretdione-containing compound has an average uretdione ring functionality of greater than 1.

Uretdiones can be formed by the 2+2 cycloaddition reaction of two isocyanate groups.

Isocyanate dimerization to form a uretdione is typically done by using a catalyst. Examples of dimerization catalysts are: trialkylphosphines, aminophosphines and aminopyridines such as dimethylaminopyridines, and tris(dimethylamino)phosphine, as well as any other dimerization catalyst known to those skilled in the art. The result of the dimerization reaction depends, in a manner known to the skilled person, on the catalyst used, on the process conditions and on the polyisocyanates employed.

By including polyisocyanate compounds, uretdione-containing compounds having an average uretdione ring functionality greater than 1 can be prepared. As used herein, the term “polyisocyanate” means any organic compound that has two or more reactive isocyanate (—NCO) groups in a single molecule such as, for example, diisocyanates, triisocyanates, tetraisocyanates, and mixtures thereof. Exemplary polyisocyanates that can be used to prepare uretdione-containing compounds include: 1) (cyclo)aliphatic diisocyanates such as 1,2-ethylene diisocyanate; 1,4-tetramethylene diisocyanate; 1,6-hexamethylene diisocyanate; 2,2,4-trimethyl-1,6-hexamethylene diisocyanate; 2,4,4-trimethyl-1,6-hexamethylene diisocyanate; 1,9-diisocyanato-5-methylnonane; 1,8-diisocyanato-2,4-dimethyloctane; 1,12-dodecane diisocyanate; ω,ω′-diisocyanatodipropyl ether; cyclobutene 1,3-diisocyanate; cyclohexane 1,3-diisocyanate; cyclohexane 1,4-diisocyanate; 3-isocyanatomethyl-3,5,5-trimethylcyclohexyl isocyanate (isophorone diisocyanate, IPDI), 1,4-diisocyanatomethyl-2,3,5,6-tetramethylcyclohexane; decahydro-8-methyl-(1,4-methanol-naphthalen)-2,5-ylenedimethylene diisocyanate; decahydro-8-methyl-(1,4-methanol-naphthalen)-3,5-ylenedimethylene diisocyanate; hexahydro-4,7-methanoindan-1,5-ylenedimethylene diisocyanate; hexahydro-4,7-methanoindan-2,5-ylenedimethylene diisocyanate; hexahydro-4,7-methanoindan-1,6-ylenedimethylene diisocyanate; hexahydro-4,7-methanoindan-2,5-ylenedimethylene diisocyanate, hexahydro-4,7-methanoindan-1,5-ylene diisocyanate; hexahydro-4,7-methanoindan-2,5-ylene diisocyanate; hexahydro-4,7-methanoindan-1,6-ylene diisocyanate; hexahydro-4,7-methanoindan-2,6-ylene diisocyanate; 2,4-hexahydrotolylene diisocyanate; 2,6-hexahydrotolylene diisocyanate; 4,4′-methylenedicyclohexyl diisocyanate; 2,2′-methylenedicyclohexyl diisocyanate; 2,4-methylenedicyclohexyl diisocyanate; 4,4′-diisocyanato-3,3′,5,5′-tetramethyldicyclohexylmethane; 4,4′-diisocyanato-2,2′,3,3,5,5′,6,6′-octamethyldicyclohexylmethane; ω,ω′-diisocyanato-1,4-diethylbenzene; 1,4-diisocyanatomethyl-2,3,5,6-tetramethylbenzene; 2-methyl-1,5-diisocyanatopentane; 2-ethyl-1,4-diisocyanatobutane; 1,10-diisocyanatodecane; 1,5-diisocyanatohexane; 1,3-diisocyanatomethylcyclohexane; 1,4-diisocyanatomethylcyclohexane; 2) aromatic diisocyanates such as 2,4-diphenylmethane diisocyanate; 4,4′-biphenylene diisocyanate; 3,3′-dimethoxy-4,4′-biphenyl diisocyanate; 3,3′-dimethyl-4, 4′-biphenyl diisocyanate; 3,3′-dimethyl-4,4′-diphenylmethane diisocyanate; xylene diisocyanate; 3-methyldiphenylmethane-4,4′-diisocyanate; 1,1-bis(4-isocyanatophenyl)cyclohexane; m- or p-phenylene diisocyanates; chlorophenylene-2,4-diisocyanate; 1,5-diisocyanatonaphthalene; 4,4′-biphenyl diisocyanate; 3,5′-dimethyldiphenyl-4,4′-diisocyanate; diphenyl ether-4,4′-diisocyanate; and 3) combinations thereof. Triisocyanates which may be used include, for example, trimerized isocyanurate versions of the diisocyanates listed above (e.g., the isocyanurate trimer of 1,6-hexamethylene diisocyanate and related compounds such as DESMODUR N 3300 from Covestro LLC, Pittsburgh, Pa.).

Mono-functional isocyanates may also be used (e.g., to vary the uretdione-containing compound average uretdione ring functionality). Examples include vinyl isocyanate; methyl isocyanatoformate; ethyl isocyanate; isocyanato(methoxy)methane; allyl isocyanate; ethyl isocyanatoformate; isopropyl isocyanate; propyl isocyanate; trimethylsilyl isocyanate; ethyl isocyanatoacetate; butyl isocyanate; cyclopentyl isocyanate; 2-isocyanato-2-methyl-propionic acid methyl ester; ethyl 3-isocyanatopropionate; 1-isocyanato-2,2-dimethylpropane; 1-isocyanato-3-methylbutane; 3-isocyanatopentane; pentyl isocyanate; 1-ethoxy-3-isocyanatopropane; phenyl isocyanate; hexyl isocyanate; 1-adamantyl isocyanate; ethyl 4-(isocyanatomethyl)cyclohexanecarboxylate; decyl isocyanate; 2-ethyl-6-isopropylphenyl isocyanate; 4-butyl-2-methylphenyl isocyanate; 4-pentylpheny isocyanate; undecyl isocyanate; 4-biphenylyl isocyanate; 4-phenoxyphenyl isocyanate; 2-benzylphenyl isocyanate; 4-benzylphenyl isocyanate; diphenylmethyl isocyanate; 4-(benzyloxy)phenyl isocyanate; hexadecyl isocyanate; octadecyl isocyanate; and combinations thereof. Preferred compounds include, for example, uretdione-containing compounds derived from hexamethylene diisocyanate.

The conversion of uretdione-containing compounds having a single uretdione ring to a uretdione-containing compound having at least 2 uretdione rings (i.e., a polyuretdione) may be accomplished by reaction of the free NCO groups with hydroxyl-containing compounds, which include monomers, polymers, or mixtures thereof. Examples of such compounds include, but are not limited to, polyesters, polythioethers, polyethers, polycaprolactams, polyepoxides, polyesteramides, polyurethanes or low molecular mass di-, tri- and/or tetraols as chain extenders, and if desired, mono-ols as chain terminators, for example, as described in EP 0 669 353, EP 0 669 354, DE 30 30 572, EP 0 639 598, EP 0 803 524, and U.S. Pat. No. 7,709,589. Useful uretdione-containing compounds may optionally contain isocyanurate, biuret, and/or iminooxadiazinedione groups in addition to the uretdione groups.

Uretdione-containing compounds having at least 2 uretdione groups, such as from 2 to 10 uretdione groups, and typically containing from 5 to 45% uretdione, 10 to 55% urethane, and less than 2% isocyanate groups are disclosed in U.S. Pat. No. 9,080,074 (Schaffer et al.).

One preferred uretdione-containing compound is a hexamethylene diisocyanate-based blend of materials comprising uretdione functional groups, commercially available as Desmodur N3400 from Covestro, Pittsburgh, Pa.

One more preferred uretdione-containing compound is uretdione-containing compound based on 3-isocyanatomethyl-3,5,5-trimethylcyclohexyl isocyanate (isophorone diisocyanate, IPDI), which is commercially available from Evonik as Vestagon BF-1320, Vestagon BF-1321, Vestagon BF-1350, Vestagon BF-1540.

Additional uretdione-containing compounds are commercially available from Covestro as Crelan EF 403, Crelan LAS LP 6645, Crelan VP LS 2386, and Metalink U/Isoqure TT from Isochem Incorporated, New Albany, Ohio.

Preferably, the uretdione-containing compound has an average uretdione ring functionality of greater than 1. Accordingly, at least some components of the uretdione-containing compound contain more than one uretdione functional group. In some embodiments, the uretdione-containing compound has an average uretdione ring functionality of 1.2 to 10, preferably 2 to 8, more preferably 3 to 6, for example 1.2, 1.5, 1.8, 2.0, 2.2, 2.5, 2.8, 3.0, 3.2, 3.5, 3.8, 4.0, 4.2, 4.5, 4.8, 5.0, 5.2, 5.5, 5.8, 6.0, 6.2, 6.5, 6.8, 7.0, 7.2, 7.5, 7.8, 8.0, 8.2, 8.5, 8.8, 9.0, 9.2, 9.5, 9.8.

The total amount of component (b) can be in the range from 1 to 50 wt. %, for example 5 wt. %, 10 wt. %, 15 wt. %, 20 wt. %, 25 wt. %, 30 wt. %, 35 wt. %, 40 wt. % or 45 wt. %, preferably from 2 to 40 wt. %, more preferably from 5 to 30 wt. %, based on the total weight of the dual-cure resin composition.

### Compound (c) Containing at Least One Isocyanate-Reactive Group

The dual-cure resin composition of the present invention comprises at least one compound containing at least one, preferably at least two isocyanate-reactive groups as component (c).

Isocyanate-reactive groups may be, for example, —OH, —SH, —NH₂, —NH—, —C(═O)NH—, or —OC(═O)NH—. They are linked with any other molecular chain or group to form compound (c) containing at least one isocyanate-reactive group.

In one embodiment, compounds (c) include monoalcohols, diols and/or polyols.

Examples of suitable compounds (c) are monoalcohols having 2 to 20 carbon atoms, examples being saturated monoalcohols, such as ethanol, n-propanol, isopropanol, n-butanol, isobutanol, sec-butanol, the isomeric pentanols, hexanols, octanols and nonanols, n-decanol, n-dodecanol, n-tetradecanol, n-hexadecanol, n-octadecanol, cyclohexanol, the isomeric methyl-cyclohexanols or hydroxymethylcyclohexane, 3-ethyl-3-hydroxymethyloxetan or tetrahydrofurfuryl alcohol; diethylene glycol monoalkyl ethers, such as, for example, diethylene glycol monobutyl ether; unsaturated monoalcohols, such as allyl alcohol, 1,1-dimethylallyl alcohol or oleic alcohol; aromatic monoalcohols, such as phenol, the isomeric cresols or methoxyphenols; araliphatic monoalcohols, such as benzyl alcohol, anis alcohol or cinnamic alcohol; including mixtures of two or more of any of the foregoing.

Examples of suitable compounds (c) are diols having 2 to 20 carbon atoms, examples being ethylene glycol, 1,2-propanediol, 1,3-propanediol, 1,1-dimethylethane-1,2-diol, 2-butyl-2-ethyl-1,3-propanediol, 2-ethyl-1,3-propanediol, 2-methyl-1,3-propanediol, neopentyl glycol, neopentyl glycol hydroxypivalate, 1,2-, 1,3- or 1,4-butanediol, 1,6-hexanediol, 1,7-heptanediol, 1,8-octanediol, 1,9-nonanediol, 1,10-decanediol, bis(4-hydroxycyclohexane)isopropylidene, tetramethylcyclobutanediol, 1,2-, 1,3- or 1,4-cyclohexanediol, cyclooctanediol, norbornanediol, pinanediol, decalindiol, 2-ethyl-1,3-hexanediol, 2,4-diethyloctane-1,3-diol, hydroquinone, bisphenol A, bisphenol F, bisphenol B, bisphenol S, 2,2-bis(4-hydroxycyclohexyl)propane, 1,1-, 1,2-, 1,3-, and 1,4-cyclohexanedimethanol, 1,2-, 1,3-, or 1,4-cyclohexanediol, resorcinol di(beta-hydroxyethyl) ether (HER), resorcinol di(beta-hydroxypropyl) ether (HPR), hydroquinone di(beta-hydroxyethyl) ether (HQEE), resorcinol di(beta-hydroxypropyl) ethyl ether (HPER).

Examples of suitable compounds (c) are also higher molecular weight polymeric polyols, for example polyester polyols, polycarbonate polyols and polyether polyols. Suitable polymeric polyols preferably have a mean OH functionality of at least 1.5 and especially at least 1.8, for example in the range from 1.5 to 10 and especially in the range from 1.8 to 4. The mean OH functionality is understood to mean the mean number of OH groups per polymer chain. Typical polymeric polyol components preferably have a number-average molecular weight of about 250 to 50 000 g/mol, preferably of about 500 to 10 000 g/mol. Preferably, at least 50 mol % of the hydroxyl groups present in the polymeric polyol component are primary hydroxyl groups.

Examples of suitable polyester polyols are linear or branched polymeric compounds having ester groups in the polymer backbone and having free hydroxyl groups at the ends of the polymer chain. Preferably, these are polyesters which are obtained by polycondensation of dihydric alcohols with dibasic carboxylic acids, optionally in the presence of higher polyhydric alcohols (e.g. tri-, tetra-, penta- or hexahydric alcohols) and/or higher polybasic polycarboxylic acids. Rather than the free di- or polycarboxylic acids, it is also possible to use the corresponding di- or polycarboxylic anhydrides or corresponding di- or polycarboxylic esters of lower alcohols or mixtures thereof for preparation of the polyester polyols. The di- or polycarboxylic acids may be aliphatic, cycloaliphatic, araliphatic, aromatic or heterocyclic, preferably have 2 to 50 and especially 4 to 20 carbon atoms and may optionally be substituted, for example by halogen atoms, and/or be unsaturated. Examples thereof include: suberic acid, azelaic acid, phthalic acid, isophthalic acid, phthalic anhydride, tetrahydrophthalic anhydride, hexahydrophthalic anhydride, tetrachlorophthalic anhydride, endomethylenetetrahydrophthalic anhydride, glutaric anhydride, maleic acid, maleic anhydride, alkenylsuccinic acid, fumaric acid and dimeric fatty acids. Useful diols for the preparation of the polyester polyols include especially aliphatic and cycloaliphatic diols having preferably 2 to 40 and especially 2 to 20 carbon atoms, for example ethylene glycol, propane-1,2-diol, propane-1,3-diol, butane-1,3-diol, butane-1,4-diol, butene-1,4-diol, butyne-1,4-diol, pentane-1,5-diol, neopentyl glycol, bis(hydroxymethyl)cyclohexanes such as 1,4-bis(hydroxymethyl)cyclohexane, 2-methylpropane-1,3-diol, methylpentanediols, and also diethylene glycol, triethylene glycol, tetraethylene glycol, polyethylene glycol, dipropylene glycol, polypropylene glycol, dibutylene glycol and polybutylene glycols. Preference is given to alcohols of the general formula HO—(CH₂)ₓ—OH, where x is a number from 2 to 20, preferably an even number from 2 to 12. Examples thereof are ethylene glycol, butane-1,4-diol, hexane-1,6-diol, octane-1,8-diol and dodecane-1,12-diol. Additionally preferred are neopentyl glycol and pentane-1,5-diol.

Polyester polyols are obtainable by ring opening polymerization of cyclic ester, preferably have 2 to 20 and especially 4 to 12 carbon atoms and may optionally be substituted, for example by halogen atoms, and/or be unsaturated. Examples thereof include: butyrolactone, valerolactone, caprolactone, decalactone.

Dendritic polyester polyols are obtainable by polymerization of a particular core and 2,2′-dimethylol propionic acid. Examples thereof include: Perstorp Boltorn H2004, H311, P1000. Examples of suitable polyester polyols are, for example, the polyester polyols known from Ullmanns Enzyklopädie der Technischen Chemie, 4th Edition, Volume 19, pages 62 to 65.

In addition, polycarbonate polyols are also useful, as obtainable, for example, by reaction of phosgene with an excess of the low molecular weight alcohols mentioned as formation components for the polyester polyols.

The polyether polyols are especially polyether polyols preparable by polymerization of ethylene oxide, propylene oxide, butylene oxide, tetrahydrofuran, styrene oxide or epichlorohydrin with themselves, for example in the presence of BF₃ or by addition of these compounds, optionally in a mixture or in succession, onto bi- or polyfunctional starter components having reactive hydrogen atoms, such as polyols or polyfunctional amines, for example water, ethylene glycol, propane-1,2-diol, propane-1,3-diol, 1,1-bis(4-hydroxyphenyl)propane, trimethylolpropane, glycerol, sorbitol, ethanolamine or ethylenediamine. Also useful are sucrose polyethers (see DE 1176358 and DE 1064938), and formitol- or formose-started polyethers (see DE 2639083 and DE 2737951).

Examples of suitable diols or polyols are especially 1,2-, 1,3- or 1,4-butanediol, 1,6-hexanediol, polytetrahydrofuran (PolyTHF) having a number-average molecular weight of about 250 to 5000 g/mol, or about 500 to 2000 g/mol, polypropylene glycol (PPG) having a number-average molecular weight of about 250 to 5000 g/mol, or about 500 to 2000 g/mol or polyethylene glycol (PEG) having a number-average molecular weight of about 250 to 5000 g/mol, or about 500 to 2000 g/mol, especially 1,4-butanediol (BDO), polypropylene glycol 1000 (PPG1000) or polytetrahydrofuran 2000 (PolyTHF2000).

Polyolefin polyols are obtainable by polymerization of allyl alcohol with butadiene, isoprene, butadiene/acrylonitrile, butadiene/styrene.

In a preferred embodiment, compounds (c) include aliphatic and cycloaliphatic monoamines, diamines or polyamines, aromatic and araliphatic monoamines, diamines or polyamines, and polymeric amines, for example amino resin, polyethylenimine (PEI) or polylysine and polyamidoamines.

Examples of suitable compounds (c) are monoamines having 2 to 22 carbon atoms, examples being secondary monoamines, such as dimethylamine, diethylamine, dipropylamine, diisopropylamine, dibutylamine, bis-(2-ethylhexyl)-amine, N-methyl- and N-ethyl-cyclohexylamine or dicyclohexylamine; heterocyclic secondary amines, such as morpholine, pyrrolidine, piperidine or 1H-pyrazole; as well as aromatic monoamines, such as aniline, C₁-C₈-alkyl substituted aniline, di-C₁-C₈-alkyl substituted aniline, C₁-C₈-alkoxy substituted aniline and di-C₁-C₈-alkoxy substituted aniline, preferably C₁-C₄-alkyl substituted aniline, di-C₁-C₄-alkyl substituted aniline, C₁-C₄-alkoxy substituted aniline and di-C₁-C₄-alkoxy substituted aniline; including mixtures of two or more of any of the foregoing.

Suitable diamines or polyamines are, for example,
aliphatic diamines or polyamines such as ethylenediamine, 1,2- and 1,3-propanediamine, neopentanediamine, hexamethylenediamine, octamethylenediamine, 1,10-diaminodecane, 1,12-diaminododecane, diethylenetriamine, triethylenetetramine, tetraethylenepentamine, 2,2-dimethylpropylenediamine, trimethylhexamethylenediamine, 1-(3-aminopropyl)-3-aminopropane, 1,3-bis(3-aminopropyl)propane, 4-ethyl-4-methylamino-1-octylamine, and the like;
cycloaliphatic diamines or polyamines, such as 1,2-diaminocyclohexane, 1,2-, 1,3-, 1,4-bis(amino-methyl)cyclohexane, 1-methyl-2,4-diaminocyclohexane, N-cyclohexylpropylene-1,3-diamine, 4-(2-aminopropan-2-yl)-1-methylcyclohexane-1-amine, isophoronediamine, 4,4′-diaminodicyclohexylmethane (Dicykan), 3,3′-dimethyl-4,4′-diaminodicyclohexylmethane, 3,3′,5,5′-tetramethyl-4,4′-diaminodicyclohexylmethane, 4,8-diaminotricyclo[5.2.1.0]decane, norbornanediamine, menthanediamine, menthenediamine, and the like;
aromatic diamines or polyamines, such as 1,4-diaminobenzene, 2,4- and/or 2,6-diaminotoluene, m-xylylenediamine (MXDA), 2,4′- and/or 4,4′-diaminodiphenylmethane, 3,3′-dimethyl-4,4′-diaminodiphenylmethane, 3,3′-dichloro-4,4′-diaminodiphenylmethane (MOCA), 3,5-dimethylthiotoluene-2,4- and/or-2,6-diamine, 1,3,5-triethyl-2,4-diaminobenzene, 1,3,5-triisopropyl-2,4-diaminobenzene, 1-methyl-3,5-diethyl-2,4- and/or-2,6-diaminobenzene (also known as 3,5-diethyltoluene-2,4- and/or-2,6-diamine, or DETDA), 4,6-dimethyl-2-ethyl-1,3-diaminobenzene, 3,5,3′,5′-tetraethyl-4,4′-diaminodiphenylmethane, 3,5,3′,5′-tetraisopropyl-4,4′-diaminodiphenylmethane, 3,5-diethyl-3′,5′-diisopropyl-4,4′-diaminodiphenylmethane, 2,4,6-triethyl-m-phenylenediamine (TEMPDA), 3,5-diisopropyl-2,4-diaminotoluene, 3,5-di-sec-butyl-2,6-diaminotoluene, 3-ethyl-5-isopropyl-2,4-diaminotoluene, 4,6-diisopropyl-m-phenylenediamine, 4,6-di-tertbutyl-m-phenylenediamine, 4,6-diethyl-m-phenylenediamine, 3-isopropyl-2,6-diaminotoluene, 5-isopropyl-2,4-diaminotoluene, 4-isopropyl-6-methyl-m-phenylenediamine, 4-isopropyl-6-tert-butyl-m-phenylenediamine, 4-ethyl-6-isopropyi-m-phenylenediamine, 4-methyl-6-tert-butyl-m-phenylenediamine, 4,6-di-sec-butyl-m-phenylenediamine, 4-ethyl-6-tertbutyl-m-phenylenediamine, 4-ethyl-6-sec-butyl-m-phenylenediamine, 4-ethyl-6-isobutyl-m-phenylenediamine, 4-isopropyl-6-isobutyl-m-phenylenediamine, 4-isopropyl-6-sec-butyl-m-phenylenediamine, 4-tert-butyl-6-isobutyl-m-phenylenediamine, 4-cyclopentyl-6-ethyl-m-phenylenediamine, 4-cyclohexyl-6-isopropyl-m-phenylenediamine, 4,6-dicyclopentyl-m-phenylenediamine, 2,2′,6,6′-tetraethyl-4,4′-methylenebisaniline, 2,2′,6,6′-tetraisopropyl-4,4′-methylenebisaniline(methylenebisdiisopropylaniline), 2,2′,6,6′-tetra-sec-butyl-4,4′-methylenebisaniline, 2,2′-dimethyl-6,6′-di-tert-butyl-4,4′-methylenebisaniline, 2,2′-di-tert-butyl-4,4′-methylenebisaniline, 4,4′-bis(sec-butyl)-methylendianiline, 2-isopropyl-2′,6′-diethyl-4,4′-methylenebisaniline, polytetramethylene glycol bis(4-aminobenzoate) with a molecular weight of from 300 to 1000 g/mol; and mixtures thereof;
cyclic polyamines, such as piperazine, N-aminoethylpiperazine, and the like;
polyetheramines, especially difunctional and trifunctional primary polyetheramines based on polypropylene glycol, polyethylene glycol, polybutylene oxide, poly(1,4-butanediol), polytetrahydrofuran (polyTHF) or polypentylene oxide, for example 4,7,10-trioxatridecane-1,3-diamine, 4,7,10-trioxatridecane-1,13-diamine, 1,8-diamino-3,6-dioxaoctane (XTJ-504 from Huntsman), 1,10-diamino-4,7-dioxadecane (XTJ-590 from Huntsman), 1,12-diamino-4,9-dioxadodecane (from BASF SE), 1,3-diamino-4,7,10-trioxatridecane (from BASF SE), primary polyetheramines based on polypropylene glycol having a mean molar mass of 230, for example polyetheramine D 230 (from BASF SE) or Jeffamine® D 230 (from Huntsman), difunctional, primary polyetheramines based on polypropylene glycol having a mean molar mass of 400, e.g. polyetheramine D 400 (from BASF SE) or Jeffamine® XTJ 582 (from Huntsman), difunctional, primary polyetheramines based on polypropylene glycol having a mean molar mass of 2000, for example polyetheramine D 2000 (from BASF SE), Jeffamine® D2000 or Jeffamine® XTJ 578 (each from Huntsman), difunctional, primary polyetheramines based on propylene oxide having a mean molar mass of 4000, for example polyetheramine D 4000 (from BASF SE), trifunctional, primary polyetheramines prepared by reacting propylene oxide with trimethylolpropane followed by an amination of the terminal OH groups, having a mean molar mass of 403, for example polyetheramine T 403 (from BASF SE) or Jeffamine® T 403 (from Huntsman), trifunctional, primary polyetheramine prepared by reacting propylene oxide with glycerol, followed by an amination of the terminal OH groups, having a mean molar mass of 5000, for example polyetheramine T 5000 (from BASF SE) or Jeffamine® T 5000 (from Huntsman), aliphatic polyetheramines formed from a propylene oxide-grafted polyethylene glycol and having a mean molar mass of 600, for example Jeffamine® ED-600 or Jeffamine® XTJ 501 (each from Huntsman), aliphatic polyetheramines formed from a propylene oxide-grafted polyethylene glycol and having a mean molar mass of 900, for example Jeffamine® ED-900 (from Huntsman), aliphatic polyetheramines formed from a propylene oxide-grafted polyethylene glycol and having a mean molar mass of 2000, for example Jeffamine® ED-2003 (from Huntsman), difunctional, primary polyetheramine prepared by amination of a propylene oxide-grafted diethylene glycol, having a mean molar mass of 220, for example Jeffamine® HK-511 (from Huntsman), aliphatic polyetheramines based on a copolymer of poly(tetramethylene ether glycol) and polypropylene glycol having a mean molar mass of 1000, for example Jeffamine® XTJ-542 (from Huntsman), aliphatic polyetheramines based on a copolymer of poly(tetramethylene ether glycol) and polypropylene glycol having a mean molar mass of 1900, for example Jeffamine® XTJ-548 (from Huntsman), aliphatic polyetheramines based on a copolymer of poly(tetramethylene ether glycol) and polypropylene glycol having a mean molar mass of 1400, for example Jeffamine® XTJ-559 (from Huntsman), polyethertriamines based on a butylene oxide-grafted, at least trihydric alcohol having a mean molar mass of 400, for example Jeffamine® XTJ-566 (from Huntsman), aliphatic polyetheramines prepared by amination of butylene oxide-grafted alcohols having a mean molar mass of 219, for example Jeffamine® XTJ-568 (from Huntsman), polyetheramines based on pentaerythritol and propylene oxide having a mean molar mass of 600, for example Jeffamine® XTJ-616 (from Huntsman), polyetheramines based on triethylene glycol having a mean molar mass of 148, for example Jeffamine® EDR-148 (from Huntsman), difunctional, primary polyetheramines prepared by amination of a propylene oxide-grafted ethylene glycol, having a mean molar mass of 176, for example Jeffamine® EDR-176 (from Huntsman), and also polyetheramines prepared by amination of polytetrahydrofuran (polyTHF) having a mean molar mass of 250, for example PolyTHF-amine 350 (BASF SE), and mixtures of these amines;
polyamidoamines (amidopolyamines), which are obtainable by reaction of dimeric fatty acids (for example dimeric linoleic acid) with polyamines of low molecular weight, such as diethylenetriamine, 1-(3-aminopropyl)-3-aminopropane or triethylenetetramine, or other diamines, such as the aforementioned aliphatic or cycloaliphatic diamines;
sterically hindered aliphatic amines, such as polyaspartic which are secondary amines obtained by the reaction of primary amines with dialkyl maleate by the Michael reaction, such as Desmophen NH 1220, Desmophen NH 1420, Desmophen NH 1520, Desmophen NH 2850, Desmophen NH 2885, Desmophen NH 2886;
sterically hindered aromatic amines, for example 4-N,N′-di-sec-butyl-4,4′-methylene dianiline (Wanalink 6200), N,N′-di-sec-butyl-p-phenyldiamine (Unilink 4100);
   and mixtures of the aforementioned amine, especially mixtures of difunctional amines from the group of the aliphatic, cycloaliphatic and aromatic amines with the aforementioned polyetheramines.

Preferred diamines or polyamines are aromatic diamines or polyamines, more preferably 4,4′-methylene dianiline (MDA), delayed action MDA (Xylink 311), diethyltoluene diamine (Ethacure 100) and N,N′-di-sec-butyl-4,4′-methylene dianiline (Wanalink 6200). Preference is also given to polytetramethylene glycol bis(4-aminobenzoate) with a molecular weight of from 300 to 1000 g/mol, preferably 400 to 800 g/mol, more preferably 500 to 700 g/mol.

In general, the compounds containing —C(═O)NH— or —OC(═O)NH— are all suitable to be used as compounds (c). The hydrogen on the amino group can be reacted with the NCO group released from the uretdione-containing compound at an elevated temperature, preferably a temperature above 100° C., more preferably 100 to 300° C., most preferably 120 to 200° C., for example under organometallic compounds such as dibutyltin dilaurate (DBTL). Examples of compounds (c) are compounds of formula R¹C(═O)NHR² or R¹OC(═O)NHR², wherein either R¹ or R² represents an alkyl group containing 1 to 4 carbon atoms, such as methyl, ethyl, n-propyl, isopropyl, n-butyl, isobutyl, sec-butyl or tert-butyl, or an aryl group containing 6 to 10 carbon atoms, such as phenyl, or polymer chain. The examples are merely used to illuminate the compounds (c) but do not pose a limitation on the scope.

Preferred compounds of formula R¹C(═O)NHR² or R¹OC(═O)NHR² are N-methylformamide, N—N-ethylbenzamide, methyl N-propylcarbamate, ethyl N-phenylcarbamate, Versamid 100, 115, 150 from Huntsman, or Elastollan AH-620F, AS-120L from BASF.

The total amount of component (c) can be in the range from 1 to 50 wt. %, for example 5 wt. %, 10 wt. %, 15 wt. %, 20 wt. %, 25 wt. %, 30 wt. %, 35 wt. %, 40 wt. % or 55 wt. %, preferably from 2 to 40 wt. %, more preferably from 5 to 30 wt. %, based on the total weight of the dual-cure resin composition.

### Photoinitiator (d)

The dual-cure resin composition comprises at least one photoinitiator as component (d). For example, the photoinitiator component (d) may include at least one free radical photoinitiator and/or at least one ionic photoinitiator, and preferably at least one (for example one or two) free radical photoinitiator. For example, it is possible to use all photoinitiators known in the art for use in compositions for 3D-printing, e.g., it is possible to use photoinitiators that are known in the art use with SLA, DLP or PPJ (Photo polymer jetting) processes.

Exemplary photoinitiators may include benzophenone, acetophenone, chlorinated acetophenone, dialkoxyacetophenones, dialkylhydroxyacetophenones, dialkylhydroxyacetophenone esters, benzoin and derivative (such as benzoin acetate, benzoin alkyl ethers), dimethoxybenzion, dibenzylketone, benzoylcyclohexanol and other aromatic ketones, alpha-aminoketone compounds, phenylglyoxylate compounds, oxime ester, acyloxime esters, acylphosphine oxides, acylphosphonates, ketosulfides, dibenzoyldisulphides, diphenyldithiocarbonate, mixtures thereof and mixtures with alpha-hydroxy ketone compounds, or alpha-alkoxyketone compounds. Examples of suitable acylphosphine oxide compounds are of the formula (XII),

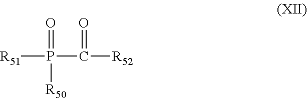

wherein
R₅₀ is unsubstituted cyclohexyl, cyclopentyl, phenyl, naphthyl or biphenylyl; or is cyclohexyl, cyclopentyl, phenyl, naphthyl or biphenylyl substituted by one or more halogen, C₁-C₁₂ alkyl, C₁-C₁₂ alkoxy, C₁-C₁₂ alkylthio or by NR₅₃R₅₄;
or R₅₀ is unsubstituted C₁-C₂₀ alkyl or is C₁-C₂₀ alkyl which is substituted by one or more halogen, C₁-C₁₂ alkoxy, C₁-C₁₂ alkylthio, NR₅₃R₅₄ or by —(CO)—O—C₁-C₂₄ alkyl;
R₅₁ is unsubstituted cyclohexyl, cyclopentyl, phenyl, naphthyl or biphenylyl; or is cyclohexyl, cyclopentyl, phenyl, naphthyl or biphenylyl substituted by one or more halogen, C₁-C₁₂ alkyl, C₁-C₁₂ alkoxy, C₁-C₁₂ alkylthio or by NR₅₃R₅₄; or R₅₁ is —(CO)R′₅₂; or R₅₁ is C₁-C₁₂ alkyl which is unsubstituted or substituted by one or more halogen, C₁-C₁₂ alkoxy, C₁-C₁₂ alkylthio, or by NR₅₃R₅₄;
R₅₂ and R′₅₂ independently of each other are unsubstituted cyclohexyl, cyclopentyl, phenyl, naphthyl or biphenylyl, or are cyclohexyl, cyclopentyl, phenyl, naphthyl or biphenylyl substituted by one or more halogen, C₁-C₄ alkyl or C₁-C₄ alkoxy; or R₅₂ is a 5- or 6-membered heterocyclic ring comprising an S atom or N atom;
R₅₃ and R₅₄ independently of one another are hydrogen, unsubstituted C₁-C₁₂ alkyl or C₁-C₁₂ alkyl substituted by one or more OH or SH wherein the alkyl chain optionally is interrupted by one to four oxygen atoms; or R₅₃ and R₅₄ independently of one another are C₂-C₁₂ alkenyl, cyclopentyl, cyclohexyl, benzyl or phenyl.

Specific examples of photoinitiators can include 1-hydroxycyclohexyl phenylketone, 2-methyl-1-[4-(methylthio)phenyl]-2-morpholinopropan-1-one, 2-benzyl-2-N,N-dimethylamino-1-(4-morpholinophenyl)-1-butanone, combination of 1-hydroxycyclohexyl phenyl ketone and benzophenone, 2,2-dimethoxy-2-phenyl acetophenone, bis(2,6-dimethoxybenzoy 1-(2,4,4-trimethylpentyl)phosphine oxide, 2-hydroxy-2-methyl-1-phenyl-propan-1-one, bis(2,4,6-trimethyl benzoyl) phenyl phosphine oxide, 2-hydroxy-2-methyl-1-phenyl-1-propane, combination of 2,4,6-trimethylbenzoyldiphenyl-phosphine oxide, 2-hydroxy-2-methyl-1-phenyl-propan-1-one, 2,4,6-trimethylbenzoyldiphenylphosphinate and 2,4,6-trimethylbenzoyldiphenyl-phosphine oxide and also any combination thereof.

In a particularly preferred embodiment, the photoinitiator (d) is a compound of the formula (XII), such as, for example, bis(2,4,6-trimethylbenzoyl)-phenylphosphine oxide; 2,4,6-trimethylbenzyldiphenyl-phosphine oxide; ethyl (2,4,6-trimethylbenzoyl phenyl) phosphinic acid ester; (2,4,6-trimethylbenzoyl)-2,4-dipentoxyphenylphosphine oxide and bis(2,6-dimethoxybenzoyl)-2,4,4-trimethylpentylphosphine oxide.

The amount of the photoinitiator (d) can be in the range from 0.1 to 10 wt. %, for example 0.2 wt. %, 0.5 wt. %, 0.8 wt. %, 1 wt. %, 2 wt. %, 3 wt. %, 5 wt. %, 8 wt. %, or 10 wt. %, preferably from 0.1 to 5 wt. %, more preferably from 0.5 to 3 wt. %, based on the total weight of the composition.

In one embodiment, the dual-cure resin composition of the present invention comprises following components:
(a) 10 to 95 wt. % of at least one photo-polymerizable compound;
(b) 1 to 50 wt. % of at least one uretdione-containing compound having an average uretdione ring functionality of greater than 1;
(c) 1 to 50 wt. % of at least one compound containing at least one isocyanate-reactive group; and
(d) 0.1 to 10 wt. % of at least one photoinitiator;
based on the total weight of the dual-cure resin composition.

In one embodiment, the dual-cure resin composition of the present invention comprises following components:
(a) 15 to 95 wt. % of at least one photo-polymerizable compound;
(b) 2 to 40 wt. % of at least one uretdione-containing compound having an average uretdione ring functionality of greater than 1;
(c) 2 to 40 wt. % of at least one compound containing at least one isocyanate-reactive group; and
(d) 0.1 to 5 wt. % of at least one photoinitiator;
based on the total weight of the dual-cure resin composition.

In one embodiment, the dual-cure resin composition of the present invention comprises following components:
(a) 30 to 85 wt. % of at least one photo-polymerizable compound;
(b) 5 to 35 wt. % of at least one uretdione-containing compound having an average uretdione ring functionality of greater than 1;
(c) 5 to 35 wt. % of at least one compound containing at least one isocyanate-reactive group; and
(d) 0.5 to 3 wt. % of at least one photoinitiator;
based on the total weight of the dual-cure resin composition.

In one embodiment, the dual-cure resin composition of the present invention comprises following components:
(a) 15 to 80 wt. % of at least one photo-polymerizable compound;
(b) 1 to 50 wt. % of at least one uretdione-containing compound having an average uretdione ring functionality of greater than 1;
(c) 1 to 50 wt. % of at least one compound containing at least one isocyanate-reactive group; and
(d) 0.1 to 10 wt. % of at least one photoinitiator;
based on the total weight of the dual-cure resin composition.

In one embodiment, the dual-cure resin composition of the present invention comprises following components:
(a) 15 to 80 wt. % of at least one photo-polymerizable compound;
(b) 2 to 40 wt. % of at least one uretdione-containing compound having an average uretdione ring functionality of greater than 1;
(c) 2 to 40 wt. % of at least one compound containing at least one isocyanate-reactive group; and
(d) 0.1 to 5 wt. % of at least one photoinitiator;
based on the total weight of the dual-cure resin composition.

In one embodiment, the dual-cure resin composition of the present invention comprises following components:
(a) 25 to 80 wt. % of at least one photo-polymerizable compound;
(b) 5 to 35 wt. % of at least one uretdione-containing compound having an average uretdione ring functionality of greater than 1;
(c) 5 to 35 wt. % of at least one compound containing at least one isocyanate-reactive group; and
(d) 0.5 to 5 wt. % of at least one photoinitiator;
based on the total weight of the dual-cure resin composition.

In one embodiment, the dual-cure resin composition of the present invention comprises following components:
(a) 20 to 70 wt. % of at least one photo-polymerizable compound;
(b) 1 to 50 wt. % of at least one uretdione-containing compound having an average uretdione ring functionality of greater than 1;
(c) 1 to 50 wt. % of at least one compound containing at least one isocyanate-reactive group; and
(d) 0.1 to 10 wt. % of at least one photoinitiator;
based on the total weight of the dual-cure resin composition.

In one embodiment, the dual-cure resin composition of the present invention comprises following components:
(a) 25 to 70 wt. % of at least one photo-polymerizable compound;
(b) 2 to 40 wt. % of at least one uretdione-containing compound having an average uretdione ring functionality of greater than 1;
(c) 2 to 40 wt. % of at least one compound containing at least one isocyanate-reactive group; and
(d) 0.1 to 5 wt. % of at least one photoinitiator;
based on the total weight of the dual-cure resin composition.

In one embodiment, the dual-cure resin composition of the present invention comprises following components:
(a) 30 to 70 wt. % of at least one photo-polymerizable compound;
(b) 5 to 35 wt. % of at least one uretdione-containing compound having an average uretdione ring functionality of greater than 1;
(c) 5 to 35 wt. % of at least one compound containing at least one isocyanate-reactive group; and
(d) 0.5 to 3 wt. % of at least one photoinitiator;
based on the total weight of the dual-cure resin composition.

### Auxiliaries

The composition of the present invention may further comprise one or more auxiliaries.

As auxiliaries, mention may be made by way of preferred example of surface-active substances, flame retardants, nucleating agents, lubricant wax, adhesion promoters, rheology modifiers, dyes, pigments, catalyst, UV absorbers and stabilizers, e.g. against oxidation, hydrolysis, light, heat or discoloration, inorganic and/or organic fillers, reinforcing materials and plasticizers. As hydrolysis inhibitors, preference is given to oligomeric and/or polymeric aliphatic or aromatic carbodiimides. To stabilize the material cured of the invention against aging and damaging environmental influences, stabilizers are added to system in preferred embodiments.

If the composition of the invention is exposed to thermo-oxidative damage during use, in preferred embodiments antioxidants are added. Preference is given to phenolic antioxidants. Phenolic antioxidants such as Irganox® 1010 from BASF SE are given in Plastics Additive Handbook, 5th edition, H. Zweifel, ed., Hanser Publishers, Munich, 2001, pages 98-107, page 116 and page 121.

If the composition of the invention is exposed to UV light, it is preferably additionally stabilized with a UV absorber. UV absorbers are generally known as molecules which absorb high-energy UV light and dissipate energy. Customary UV absorbers which are employed in industry belong, for example, to the group of cinnamic esters, diphenylcyan acrylates, formamidines, benzylidenemalonates, diarylbutadienes, triazines and benzotriazoles. Examples of commercial UV absorbers may be found in Plastics Additive Handbook, 5th edition, H. Zweifel, ed, Hanser Publishers, Munich, 2001, pages 116-122.

If the composition of the invention is liable to degrade thermally at thermal treatment, it is preferably additionally to accelerate with a catalyst. Catalysts for urethanes have been proven to reduce reaction temperature and/or time efficiently. Examples of catalysts that can be used here are organometallic compounds, such as complexes of tin, of zinc, of titanium, of zirconium, of iron, of mercury, or of bismuth, preferably organotin compounds, such as stannous salts of organic carboxylic acids, e.g. stannous acetate, stannous octoate, stannous ethylhexanoate, and stannous laurate, and the dialkyltin(IV) salts of carboxylic acids, e.g. dibutyltin diacetate, dibutyltin dilaurate (DBTL), dibutyltzin maleate, and dioctyltin diacetate, and also phenylmercury neodecanoate, bismuth carboxylates, such as bismuth(III) neodecanoate, bismuth 2-ethylhexanoate, and bismuth octanoate, or a mixture. Other possible catalysts are basic amine catalysts. Examples of these are amidines, such as 2,3-dimethyl-3,4,5,6-tetrahydropyrimidine, tertiary amines, such as triethylamine, triethylenediamine, tributylamine, dimethylbenzylamine, N-methyl, N-ethyl, N-cyclohexylmorpholine, N,N,N′,N′-tetramethylethylenediamine, N,N,N′,N′-tetramethylbutanediamine, N,N,N′,N′-tetramethylhexanediamine, pentamethyldiethylenetriamine, tetramethyldiaminoethyl ether, bis(dimethylaminopropyl)urea, dimethylpiperazine, 1,2-dimethylimidazole, 1-azabicyclo[3.3.0]octane, and preferably 1,4-diazabicyclo[2.2.2]octane,1,8-diazabicyclo[5.4.0]-undecen-7-ene, and alkanolamine compounds, such as triethanolamine, triisopropanolamine, N-methyl- and N-ethyldiethanolamine, and dimethylethanolamine. The catalysts can be used individually or in the form of a mixture.

The dual-cure resin composition of the present invention can optionally comprise at least one impact modifier.

In one embodiment, the impact modifier can be selected from acrylic rubbers, ASA rubbers, diene rubbers, organosiloxane rubbers, EPDM rubbers, SBS or SEBS rubbers, ABS rubbers, MBS rubbers, glycidyl esters, polystyrene-polybutadiene, polystyrene-poly(ethylene-propylene), polystyrene-polyisoprene, poly(α-methylstyrene)-polybutadiene, polystyrene-polybutadienepolystyrene, polystyrene-poly(ethylene-propylene)-polystyrene, polystyrene-polyisoprenepolystyrene, poly(α-methylstyrene)-polybutadiene-poly(α-methylstyrene), methylmethacrylatebutadiene-styrene (MBS) and methylmethacrylate-butylacrylate, polyalkylacrylates grafted with polymethylmethacrylate, polyalkylacrylates grafted with styrene-acrylonitrile co-polymer, polyolefins grafted with poly ethylmethacrylate, polyolefins grafted with styrene-acrylonitrile co-polymer, butadiene core-shell polymers, polyphenylene ether-polyamide, polyamides, styrene-acrylonitrile co-polymer, styrene-acrylonitrile co-polymer grafted onto polybutadiene, or a combination of any two or more.

Further details regarding the abovementioned auxiliaries may be found in the specialist literature, e.g. in Plastics Additive Handbook, 5th edition, H. Zweifel, ed, Hanser Publishers, Munich, 2001.

According to the present invention, the auxiliary can be present in an amount of from 0 to 50% by weight, from 0.01 to 50% by weight, for example from 0.5 to 30% by weight, based on the total weight of the dual-cure resin composition.

### Preparation of the Composition

A further aspect of this disclosure relates to a process of preparing the dual-cure resin composition of the present invention, comprising mixing the components of the composition.

According to one embodiment of the invention, the preparation of homogeneous, storage-stable mixture is carried out in steps as follows. First, uretdione-containing compound is dissolved in at least one photo-polymerizable compound (a) at room temperature or preferably at an elevated temperature (for example from 35 to 80° C., preferably from 40 to 70° C.) with mechanical stirring. There is no particular restriction on the time of mixing and rate of stirring, as long as uretdione-containing compound is completely dissolved. In a specific embodiment, the mixing can be carried out at 100 to 3000 RPM, preferably 1500 to 2500 RPM for 5 to 60 min, more preferably 10 to 30 min. Next, the rest of components are added to the uretdione-containing compound pre-mixture to mix together uniformly at the same temperature and stirring condition.

### 3D-Printed Object and Preparation Thereof

One aspect of the present disclosure relates to a process of forming 3D-printed object, comprising using the dual-cure resin composition of the present invention or the dual-cure resin composition obtained by the process of the present invention.

In one embodiment, the process of forming 3D object comprises the following steps:
(i) applying radiation to cure the dual-cure resin composition according to the present invention layer by layer to form an intermediate 3D object;
(ii) removing the excessive liquid resin from the intermediate object obtained in step (i), optionally followed by radiation post-curing the intermediate 3D object obtained in step (i) as a whole; and
(iii) thermal treating the object obtained in step (ii) as a whole to form a final 3D object.

In a specific embodiment, the wavelength of the radiation light can be in the range from 350 to 480 nm, for example 355, 360, 365, 385, 395, 405, 420, 430, 440, 450, 460, 470 nm. The energy of radiation can be in the range from 0.5 to 2000 mw/cm², for example 1 mw/cm², 2 mw/cm² 3 mw/cm², 4 mw/cm², 5 mw/cm², 8 mw/cm², 10 mw/cm², 20 mw/cm², 30 mw/cm², 40 mw/cm², or 50 mw/cm², 100 mw/cm², 200 mw/cm², 400 mw/cm², 500 mw/cm², 1000 mw/cm², 1500 mw/cm² or 2000 mw/cm², preferably from 0.5 to 50 mw/cm² for digital light processing or from 0.5 to 400 mw/cm² for stereolithography or from 0.5 to 2000 mw/cm² for photopolymer jetting. The radiation time can be in the range from 0.5 to 10 s, preferably from 0.6 to 6 s.

The process of forming 3D-printed objects can include stereolithography (SLA), digital light processing (DLP) or photopolymer jetting (PPJ) and other technique known by the skilled in the art. Preferably, the production of cured 3D objects of complex shape is performed for instance by means of stereolithography, which has been known for a number of years. In this technique, the desired shaped article is built up from a dual-cure resin composition with the aid of a recurring, alternating sequence of two steps (1) and (2). In step (1), a layer of the dual-cure resin composition, one boundary of which is the surface of the composition, is cured with the aid of appropriate imaging radiation, preferably imaging radiation from a computer-controlled scanning laser beam, within a surface region which corresponds to the desired cross-sectional area of the shaped article to be formed, and in step (2) the cured layer is covered with a new layer of the dual-cure resin composition, and the sequence of steps (1) and (2) is often repeated until the desired shape is finished.

The means for thermal treatment in step (iii) is not generally critical, and may be chosen from any number of means generally available for heating materials. Particular examples of such means include, without limitation, radiant heating, e.g. microwave irradiating, inductive heating, infrared tunnels, or heating in an oven or furnace, e.g. an electric or gas forced air oven.

Usually, the temperature in thermal treatment in step (iii) is in the range from 80 to 270° C., preferably 100 to 220° C., more preferably 120 to 200° C. According to the invention, the treating time in step (iii) can be in the range from 0.5 to 20 h, for example 1 h, 2 h, 3 h, 4 h, 5 h, 6 h, 7 h, 8 h, 9 h, 10 h, 11 h, 12 h, 13 h, 14 h, 15 h, 16 h, 17 h, 18 h, 19 h, preferably from 3 to 18 h.

In some cases, a plurality of step (iii) using different temperature and time is taken for optimized results, for example, 100° C., 3 h+200° C., 3 h; or 130° C., 3 h+160° C., 6 h+180° C., 1 h.

A further aspect of the present disclosure relates to use of the dual-cure resin composition of the present invention for forming 3D objects.

A further aspect of the present disclosure relates to a 3D-printed object formed from the dual-cure resin composition of the present invention or obtained by the process of the present invention.

The 3D-printed objects can include plumbing fixtures, household, toy, jig, mould and interior part and connector within a vehicle.

### EXAMPLES

The present invention is further illustrated by the following examples, which are set forth to illustrate the present invention and is not to be construed as limiting thereof. Unless otherwise noted, all parts and percentages are by weight.

### Materials and Abbreviations

### Component (a):

BRC-843D: bifunctional urethane acrylate, Bomar BRC-843D, manufactured by Dymax;
VMOX: N-vinyl-5-methyl oxazolidinone, manufactured by BASF;
ACMO: acryloyl morpholine, manufactured by KJ Chemicals;
G4247: aliphatic urethane methacrylate, Genomer 4247, manufactured by RAHN AG;

### Component (b)

BF-1320: uretdione-containing compound, NCO content (latent): 13.5 to 15.0%, average uretdione ring functionality: 3.5, Vestagon BF-1320, manufactured by Evonik Degussa.

### Component (c)

BDO: 1,4-butanediol, manufactured by Sigma Aldrich;
Xylink 311:

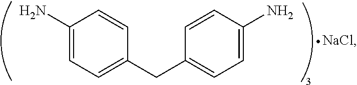

delayed action diamine curative which is approximately 47% dispersion of methylene dianiline/sodium chloride complex in dioctyl adipate (DOA), manufactured by Suzhou Xiangyuan New Materials Co., Ltd.;
E100:

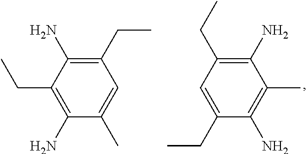

diethyltoluene diamine, Ethacure 100;
Wanalink 6200:

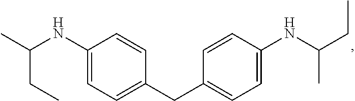 [SMILES: CCC(C)Nc1ccc(Cc2ccc(NC(C)CC)cc2)cc1]

N,N′-di-sec-butyl-4,4′-methylene dianiline, manufactured by Wanhua Chemical;
P-1000:

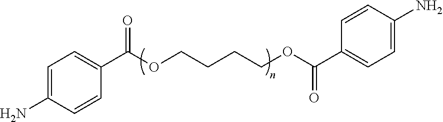

(Eqv. Wt: 620 g/mol), polytetramethylene glycol bis(4-aminobenzoate), Xylink P-1000, manufactured by Suzhou Xiangyuan New Materials Co., Ltd.

### Component (d)

TPO: 2,4,6-trimethylbenzoyldiphenylphosphine oxide, Omnirad TPO, manufactured by IGM Resins.

### Methods

### (1) Tensile Test

Tensile tests were carried out according to ISO 527-5A:2009 with Zwick, Z050 Tensile equipment, wherein the parameters used include: Start position: 50 mm; Pre-load: 0.02 MPa; Test speed: 10 mm/min. The calculated results were based on 6 replicates.

### (2) Viscosity

The viscosity of liquid resin was determined at 100 s⁻¹ shear rate with an Anton Paar Rheometer (Physica MCR 302) with a cone plate CP50 at 25° C.

### (3) Izod Notched Impact Strength

Izod notched impact strength was measured according to the standard ASTM D256 on Zwick Roell HIT25P testing machine. The calculated results were based on 6 replicates.

### Composition Preparation:

The compositions of Comparative Examples 1 and 2 were obtained by mixing the components in amounts shown in Tables 2 and 4.

The dual-cure resin compositions of Examples 1 to 11 were prepared by dosing the components in amounts as shown in Tables 1 to 4. First, Component (b) was dissolved in Component (a) at 60° C. with mechanical stirring at 1000 RPM, until Component (b) was completely dissolved. Next, the rest of components were added to the pre-mixture of Component (a) and Component (b) to mix together uniformly at the same temperature and stirring condition.

### Composition Stability—Viscosity Over Time at 25° C.

The viscosities of the dual-cure resin compositions of Examples 1 to 3 after storage for a certain period at room temperature were shown in Table 1.

TABLE 1

| | Exam- | Exam- | Exam- |
|---|---|---|---|
| | ple 1 | ple 2 | ple 3 |
| | parts | parts | parts |
| | by | by | by |
| Components | weight | weight | weight |
| VMOX | 50 | 50 | 50 |
| BRC-843D | 50 | 50 | 50 |
| BF-1320 | 15 | 15 | 15 |
| BDO | 2.25 | | |
| P-1000 | | 12.4 | 15.5 |
| TPO | 2 | 2 | 2 |
| Total | 119.25 | 129.4 | 132.5 |
| Viscosity at 25° C. (mPa · s) - Initially | 1007.2 | | |
| Viscosity at 25° C. (mPa · s) - 2 days | | 3014 | 3059 |
| Viscosity at 25° C. (mPa · s) - 1 week | | 2987 | 3044 |
| Viscosity at 25° C. (mPa · s) - 2 weeks | 1061.6 | 2879 | 2977 |
| Viscosity at 25° C. (mPa · s) - 3 weeks | | 2891 | 3010 |
| Viscosity at 25° C. (mPa · s) - 4 weeks | | 2908 | 3020 |

As could be seen from Table 1, the viscosities of the dual-cure resin compositions of Examples 1 to 3 change slightly after storage for a certain period at room temperature.

### Specimen Casting:

The dual-cure resin compositions of Examples 1 to 8 and the composition of Comparative Example 1 were prepared into test specimens using UV casting method, during which the compositions were poured into a pre-defined Teflon/silicone mould followed by UV irradiation. UV-curing of the compositions was done by using a UV conveyor belt (385 nm and 405 nm wavelengths). The UV dose applied was 3600 mJ/cm² for each side. Then, the specimens were UV post-cured by using a NextDentTM LC 3D Printbox (315 to 550 nm wavelength) for 40 mins. Then, thermal curing was performed by heating specimens in a conventional oven at 160° C. for 18 hours.

The physical properties of the cured specimens obtained from the dual-cure resin compositions of Examples 1 to 8 and the composition of Comparative Example 1 via casting were shown in Tables 2 and 3.

TABLE 2

| | Comparative Example 1 | Example 1 |
|---|---|---|
| Thermal condition | 160° C. 18 h | 160° C. 18 h |
| Components | parts by weight | parts by weight |
| VMOX | 50 | 50 |
| BRC-843D | 50 | 50 |
| BF-1320 | | 15 |
| BDO | | 2.25 |
| TPO | 2 | 2 |
| Total | 102 | 119.25 |
| Tensile strength (MPa) | 37.7 | 35.1 |
| Elongation at break (%) | 52.5 | 52.9 |
| Izod notched impact | 50 | 53.5 |
| strength (J/m) | | |

TABLE 3

| | Example 2 | Example 3 | Example 4 | Example 5 | Example 6 | Example 7 | Example 8 |
|---|---|---|---|---|---|---|---|
| Thermal condition | 160° C. 18 h | 160° C. 18 h | 160° C. 18 h | 160° C. 18 h | 160° C. 18 h | 160° C. 18 h | 160° C. 18 h |
| Components | parts by weight | parts by weight | parts by weight | parts by weight | parts by weight | parts by weight | parts by weight |
| VMOX | 50 | 50 | 50 | 50 | 50 | 50 | 50 |
| BRC-843D | 50 | 50 | 50 | 50 | 50 | 50 | 50 |
| BF-1320 | 15 | 15 | 15 | 15 | 15 | 15 | 15 |
| Xylink 311 | | | | | 12.5 | | |
| E100 | | | | | | 2.5 | |
| Wanalink 6200 | | | | | | | 7.5 |
| P-1000 | 12.4 | 15.5 | 23.25 | 31 | | | |
| TPO | 2 | 2 | 2 | 2 | 2 | 2 | 2 |
| Total | 129.4 | 132.5 | 140.25 | 148 | 129.5 | 119.5 | 124.5 |
| Tensile strength (MPa) | 35.3 | 29.4 | 28.1 | 28.1 | 37.2 | 36.7 | 32.6 |
| Elongation at break (%) | 74 | 69 | 97 | 111 | 40 | 44.6 | 63.8 |
| Izod notched impact strength | 287 | 180.2 | 252 | 317 | 142 | 92 | 271 |
| (J/m) | | | | | | | |

### Specimen 3D-Printing:

The dual-cure resin compositions of Examples 9 to 11 and the composition of Comparative Example 2 were printed using a MiiCraft 150 3D printer, which is a desktop Digital Light Processing (DLP) 3D printer with light wavelength at 405 nm. For a typical printing process, the compositions were loaded into a vat within the printer. Detailed printing parameters are summarized as follows: Printed parameter: 40° C. (actual tank temperature 36° C.), layer resolution 50 μm, curing time 3 s, base curing time 6 s; base layer 1; buffer layer 1; power 80% (light intensity 4.7-4.8 mW/cm²); The as-printed specimens were then post-cured in a UV post-curing device NextDent™ LC 3D Printbox for 40 min. At last the post-cured specimens were heated up to 160° C. for 18 h in a conventional oven to get the final object. Pre-test conditioning parameters: 1) 80° C. 24 h; 2) 25° C. 50% Relative Humidity (RH) 24 h. Test condition: 21.5° C., 27% RH.

The physical properties of the cured specimens obtained from the dual-cure resin composition of Examples 9 to 11 and the composition of Comparative Example 2 via 3D-printing were shown in Table 4.

TABLE 4

| | Comparative | | | |
|---|---|---|---|---|
| | Example 2 | Example 9 | Example 10 | Example 11 |
| Thermal condition | 160° C. 18 h | 160° C. 18 h | 160° C. 18 h | 160° C. 18 h |
| Components | parts by weight | parts by weight | parts by weight | parts by weight |
| ACMO | 30 | 30 | 30 | 30 |
| VMOX | 15 | 15 | 15 | 15 |
| BRC-843D | 45 | 45 | 45 | 45 |
| G4247 | 10 | 10 | 10 | 10 |
| BF-1320 | 0 | 15 | 11.25 | 7.5 |
| P-1000 | 0 | 15.5 | 15.5 | 15.5 |
| TPO | 2 | 2 | 2 | 2 |
| Total | 102 | 132.5 | 128.75 | 125 |
| Tensile strength (MPa) | 56.8 | 47.7 | 38.2 | 36.4 |
| Elongation at break (%) | 11.5 | 70 | 50 | 41 |
| Izod notched impact | 36.3 | 121 | 77 | 48.7 |
| strength (J/m) | | | | |

1.-17. (canceled)

18. A dual-cure resin composition comprising
(a) at least one photo-polymerizable compound;
(b) at least one uretdione-containing compound having an average uretdione ring functionality of greater than 1;
(c) at least one compound containing at least one isocyanate-reactive group; and
(d) at least one photoinitiator.

19. The dual-cure resin composition according to claim 18, wherein component (a) comprises at least one monomer and/or oligomer containing one or more ethylenically unsaturated functional groups.

20. The dual-cure resin composition according to claim 18, wherein the amount of component (a) is in the range from 10 to 95 wt. % based on the total weight of the dual-cure resin composition.

21. The dual-cure resin composition according to claim 19, wherein the monomer includes (meth)acrylamides, (meth)acrylates, vinylamides, vinyl substituted heterocycles, di-substituted alkenes and mixtures thereof.

22. The dual-cure resin composition according to claim 19, wherein the oligomer containing one or more ethylenically unsaturated functional groups is selected from the following classes: urethane, polyether, polyester, polycarbonate, polyestercarbonate, epoxy, polybutadiene, silicone or any combination thereof.

23. The dual-cure resin composition according to claim 19, wherein component (a) comprises at least one monomer and oligomer containing one or more ethylenically unsaturated functional groups and the weight ratio of the monomer to the oligomer in component (a) is in the range from 10:90 to 90:10.

24. The dual-cure resin composition according to claim 18, wherein the uretdione-containing compound has an average uretdione ring functionality of 1.2 to 10.

25. The dual-cure resin composition according to claim 18, wherein the uretdione-containing compound is based on the (cyclo)aliphatic diisocyanates.

26. The dual-cure resin composition according to claim 18, wherein the total amount of component (b) is in the range from 1 to 50 wt. % based on the total weight of the dual-cure resin composition.

27. The dual-cure resin composition according to claim 18, wherein component (c) comprises monoalcohols, diols and/or polyols.

28. The dual-cure resin composition according to claim 18, wherein component (c) comprises aromatic monoamines, diamines and/or polyamines.

29. The dual-cure resin composition according to claim 18, wherein the total amount of component (c) is in the range from 1 to 50 wt. % based on the total weight of the dual-cure resin composition.

30. The dual-cure resin composition according to claim 18, wherein the dual-cure resin composition exhibits no more than 10% change in viscosity at 25° C. after storage for 1, 2, 3 or 4 weeks at room temperature.

31. A process of forming 3D object, comprising the following steps:
(i) applying radiation to cure the dual-cure resin composition according to claim 18 layer by layer to form an intermediate 3D object;
(ii) removing the excessive liquid resin from the intermediate object obtained in step (i), optionally followed by radiation post-curing the intermediate 3D object obtained in step (i) as a whole; and
(iii) thermal treating the object obtained in step (ii) as a whole to form a final 3D object.

32. Use of the dual-cure resin composition according to claim 18 for forming 3D objects.

33. A 3D object formed from the dual-cure resin composition according to claim 18.

34. The 3D object according to claim 33, wherein the 3D object includes plumbing fixtures, household, toy, jig, mould and interior part and connector within a vehicle.
